(19) United States
(12) Patent Application Publication
(10) Pub. No.: US 2021/0255327 A1
(43) Pub. Date: Aug. 19, 2021

(54) Emission And Reception Of Patterned Light Waves For Range Sensing

(71) Applicant: MediaTek Inc., Hsinchu City (TW)

(72) Inventors: Chao-Chung Cheng, Hsinchu City (TW); Te-Hao Chang, Hsinchu City (TW); Ying-Jui Chen, Hsinchu City (TW)

(21) Appl. No.: 16/792,533

(22) Filed: Feb. 17, 2020

(51) Int. Cl. G01S 17/894; G01C 3/08; G01S 17/32; G01S 17/10

(52) U.S. Cl. CPC G01S 17/894; G01S 17/10; G01S 17/32; G01C 3/08

(57) ABSTRACT

Various examples pertaining to emission and reception of patterned light waves for range sensing are described. An apparatus emits a light having a spatial pattern toward a scene. The apparatus performs range sensing of the scene using a hybrid of techniques based on a plurality of effects caused by the emitting of the light. The plurality of techniques include two or more active depth sensing techniques or a passive depth sensing technique and at least one active depth sensing technique.

### TECHNICAL FIELD

The present disclosure is generally related to range sensing and, more particularly, to a method and apparatus for emission and reception of patterned light waves for range sensing.

### BACKGROUND

Unless otherwise indicated herein, approaches described in this section are not prior art to the claims listed below and are not admitted as prior art by inclusion in this section.

Range sensing can involve active depth sensing and/or passive depth sensing. Active depth sensing can be implemented using time-of-flight (TOF), structured light, and active stereo, and typically involves one dot projector with stereo sensor(s). In TOF, ranging is performed by a sensor measuring a phase difference in reflected signals emitted by a projector. With structured light, a dot projector and a sensor are adjusted to perform ranging using triangulation. With active stereo, two stereo sensors are adjusted to perform ranging using triangulation. On the other hand, passive depth sensing can be implemented using passive stereo. With passive stereo, as there is no dot projector, ranging is performed using triangulation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, solutions, concepts, designs, methods and apparatuses for range sensing with a light having a spatial pattern using two or more techniques such as two or more active depth sensing techniques or a passive depth sensing technique and at least one active depth sensing technique. The proposed schemes may be implemented in various applications such as, for example, active stereo vision, virtual reality and augmented reality.

In one aspect, a method may involve emitting a light having a spatial pattern toward a scene. The method may also involve performing range sensing of the scene using a plurality of techniques based on a plurality of effects caused by the emitting of the light.

In another aspect, a method may involve a control circuit controlling a light emitter to emit a light having a spatial pattern toward a scene. The method may also involve the control circuit receiving sensor data of the scene from one or more sensors. The method may further involve the control circuit performing range sensing of the scene using a plurality of techniques based on the sensor data.

In yet another aspect, an apparatus may include a light emitter configured to emit a light having a spatial pattern, one or more sensors configured to capture images, and a control circuit coupled to the light emitter and the one or more sensors. The control circuit may be configured to control the light emitter to emit the light having toward a scene. The control circuit may be also configured to receive sensor data of the scene from one or more sensors. The control circuit may be also configured to perform range sensing of the scene using a plurality of techniques based on the sensor data.

It is noteworthy that, although description provided herein may be in the context of certain EM wave spectra and light-emitting topologies such as infrared (IR) and light-emitting diode (LED), the proposed concepts, schemes and any variation(s)/derivative(s) thereof may be implemented in, for and by other EM wave spectra and/or light-emitting technologies such as, for example and without limitation, laser, light detection and ranging (LiDAR). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example apparatus in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Under various proposed schemes in accordance with the present disclosure, range sensing may be performed by emitting a light having a spatial pattern and detecting a range or depth using a hybrid of multiple range sensing techniques such as, for example and without limitation, multiple active depth sensing techniques or a passive depth sensing technique and at least one active depth sensing technique. As mentioned above, active depth sensing may be implemented with TOF, structured light and active stereo, and passive depth sensing may be implemented with passive stereo. Under the various proposed schemes, basic components utilized in emission and reception of patterned light waves for range sensing may include a light emitter and at least one sensor. The light emitter, or light projector, may be configured to emit a light having a spatial pattern (e.g., multiple dots that are separate from one another spatially). Moreover, the light emitter may be configured to emit light with a wave function. For instance, the light emitter may emit continuous waves with the spatial pattern or, alternatively, the light emitter may emit pulsed signals with the spatial pattern. The at least one sensor may be configured to sense a specific spectrum of light (e.g., light in the IR spectrum and/or light in the visible spectrum). The at least one sensor may be also configured to sense the phase of reflected light waves.

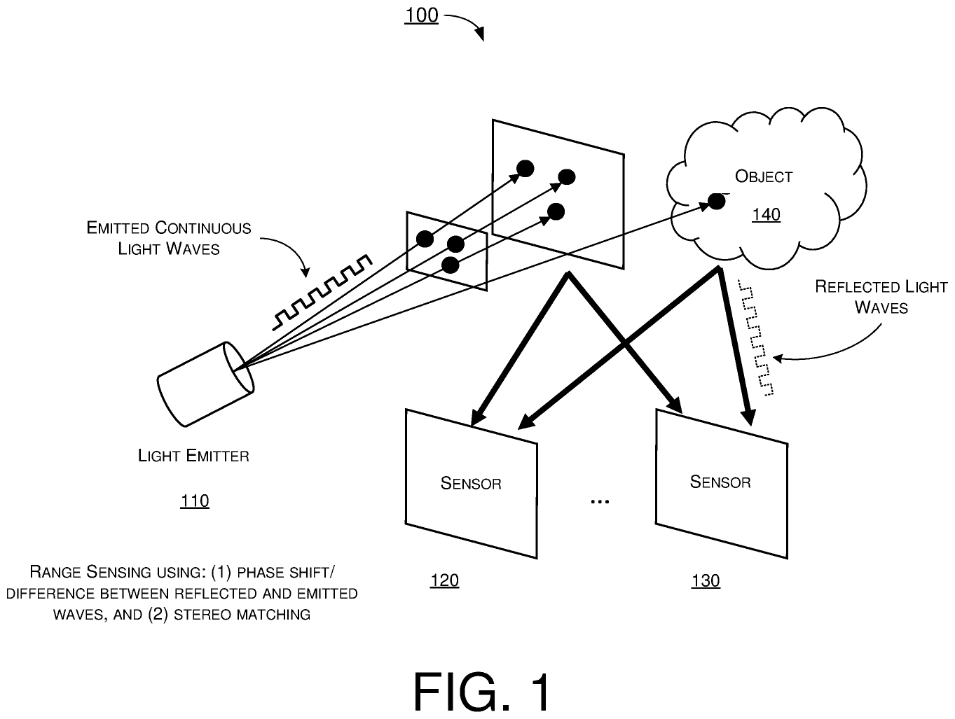

FIG. 1 is a diagram of an example scenario 100 in accordance with an implementation of the present disclosure. Scenario 100 may involve a light source or light emitter 110, a first sensor 120 and a second sensor 130. Light emitter 110 may emit a light in the form of continuous waves having a spatial pattern toward a scene having an object 140. For illustrative purposes and without limiting the scope of the present disclosure, the spatial pattern is shown as three dots in FIG. 1 although any different spatial pattern may be used in various implementations of the concept of the present disclosure. First sensor 120 and second sensor 130 may receive reflected light waves (e.g., reflected by object 140) to generate sensor data accordingly. The sensor data may indicate or otherwise represent a number of effects caused by emission and reflection of light. The plurality of effects caused by the emission and reflection of the light may include, for example and without limitation, a phase shift in reflected waves of the light, a time delay in reflected waves of the light, and/or a change in distance between features in the spatial pattern. The sensor data may be used to compute a range or distance of object 140 for range sensing. For instance, in scenario 100, a phase shift in the reflected light waves may be detected to calculate traveling time of the reflected light waves utilized in the TOF technique which, in conjunction with stereo matching utilized in the active stereo or passive stereo technique, may be used to determine the range or distance of object 140.

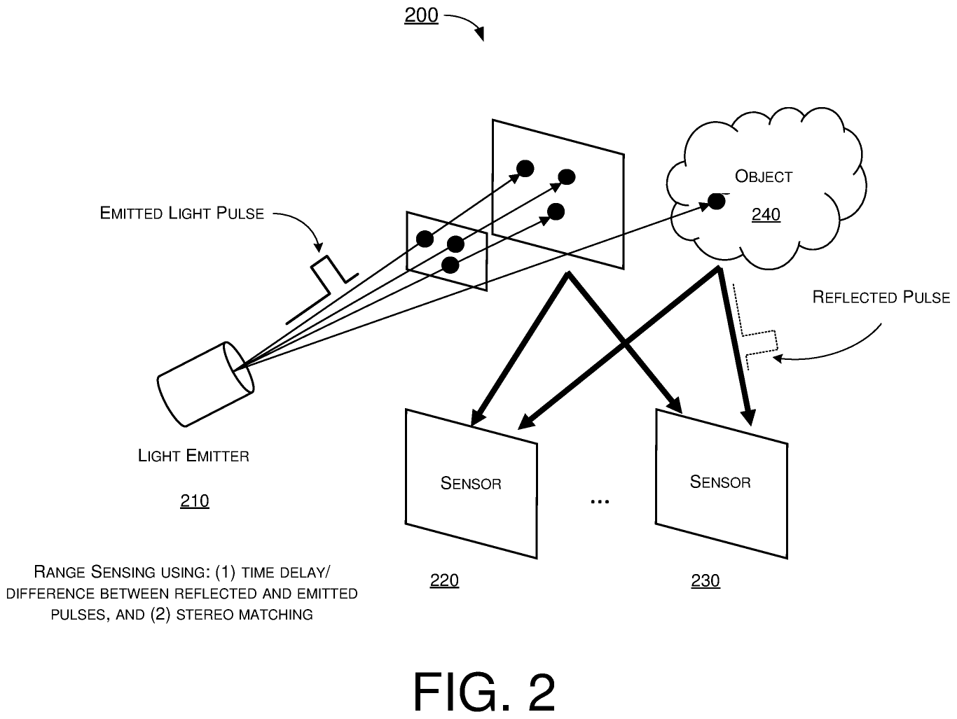

FIG. 2 is a diagram of an example scenario 200 in accordance with an implementation of the present disclosure. Scenario 200 may involve a light source or light emitter 210, a first sensor 220 and a second sensor 230. Light emitter 210 may emit a light in the form of pulsed signals (e.g. periodic or aperiodic pulses) having a spatial pattern toward a scene having an object 240. For illustrative purposes and without limiting the scope of the present disclosure, the spatial pattern is shown as three dots in FIG. 2 although any different spatial pattern may be used in various implementations of the concept of the present disclosure. First sensor 220 and second sensor 230 may receive reflected light waves (e.g., reflected by object 240) to generate sensor data accordingly. The sensor data may indicate or otherwise represent a number of effects caused by emission and reflection of light. The plurality of effects caused by the emission and reflection of the light may include, for example and without limitation, a phase shift in reflected waves of the light, a time delay in reflected waves of the light, and/or a change in distance between features in the spatial pattern. The sensor data may be used to compute a range or distance of object 240 for range sensing. For instance, in scenario 200, a time delay in the reflected light waves may be detected to calculate traveling time of the reflected light waves utilized in the TOF technique which, in conjunction with stereo matching utilized in the active stereo or passive stereo technique, may be used to determine the range or distance of object 240.

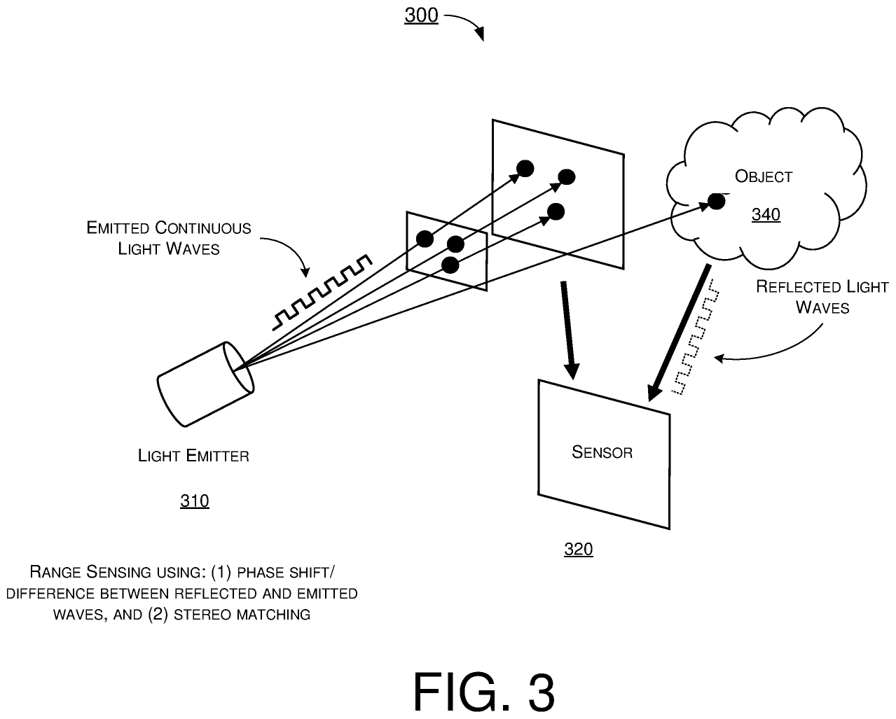

FIG. 3 is a diagram of an example scenario 300 in accordance with an implementation of the present disclosure. Scenario 300 may involve a light source or light emitter 310 and a sensor 320. Light emitter 310 may emit a light in the form of continuous waves having a spatial pattern toward a scene having an object 340. For illustrative purposes and without limiting the scope of the present disclosure, the spatial pattern is shown as three dots in FIG. 3 although any different spatial pattern may be used in various implementations of the concept of the present disclosure. Sensor 320 may receive reflected light waves (e.g., reflected by object 340) to generate sensor data accordingly. The sensor data may indicate or otherwise represent a number of effects caused by emission and reflection of light. The plurality of effects caused by the emission and reflection of the light may include, for example and without limitation, a phase shift in reflected waves of the light, a time delay in reflected waves of the light, and/or a change in distance between features in the spatial pattern. The sensor data may be used to compute a range or distance of object 340 for range sensing. For instance, in scenario 300, a phase shift in the reflected light waves may be detected to calculate traveling time of the reflected light waves utilized in the structured light technique which, in conjunction with stereo matching utilized in the active stereo or passive stereo technique, may be used to determine the range or distance of object 340.

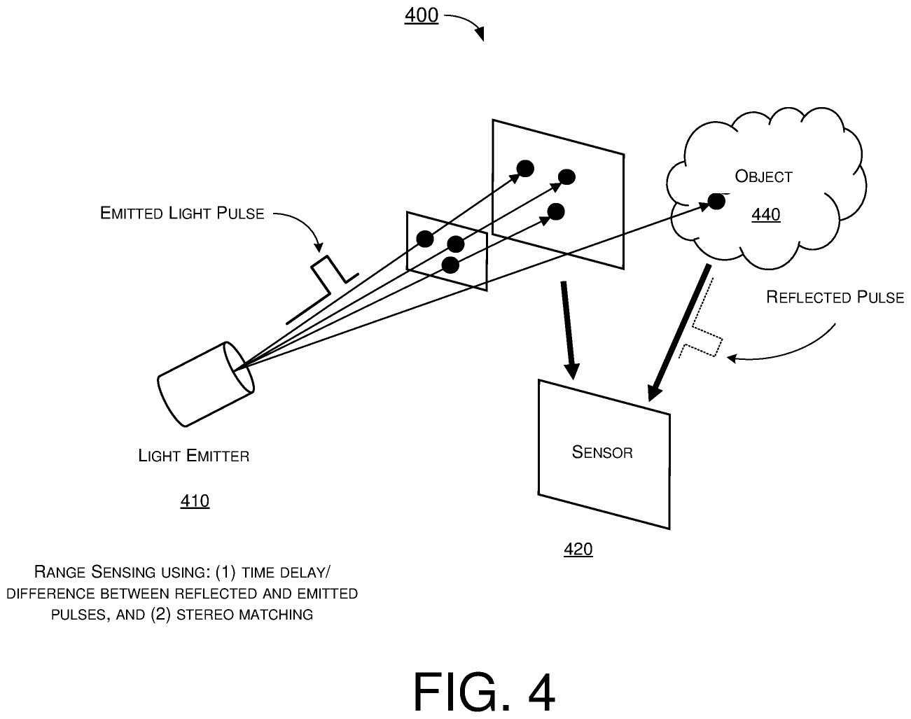

FIG. 4 is a diagram of an example scenario 400 in accordance with an implementation of the present disclosure. Scenario 400 may involve a light source or light emitter 410 and a sensor 420. Light emitter 410 may emit a light in the form of continuous waves having a spatial pattern toward a scene having an object 440. For illustrative purposes and without limiting the scope of the present disclosure, the spatial pattern is shown as three dots in FIG. 4 although any different spatial pattern may be used in various implementations of the concept of the present disclosure. Sensor 420 may receive reflected light waves (e.g., reflected by object 440) to generate sensor data accordingly. The sensor data may indicate or otherwise represent a number of effects caused by emission and reflection of light. The plurality of effects caused by the emission and reflection of the light may include, for example and without limitation, a phase shift in reflected waves of the light, a time delay in reflected waves of the light, and/or a change in distance between features in the spatial pattern. The sensor data may be used to compute a range or distance of object 440 for range sensing. For instance, in scenario 400, a time delay in the reflected light waves may be detected to calculate traveling time of the reflected light waves utilized in the structured light technique which, in conjunction with stereo matching utilized in the active stereo or passive stereo technique, may be used to determine the range or distance of object 440.

### Illustrative Implementations

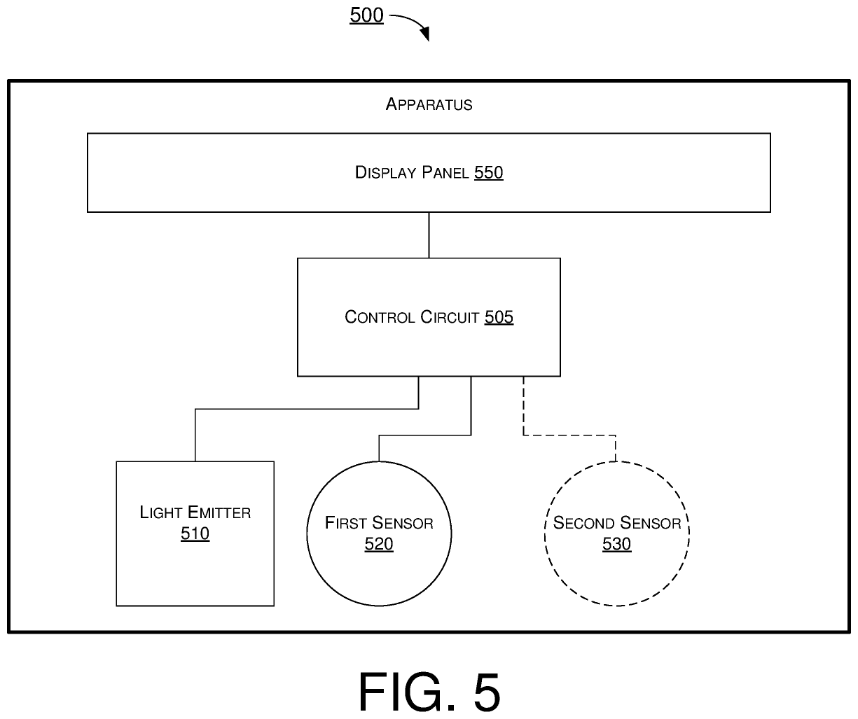

FIG. 5 illustrates an example apparatus 500 in accordance with an implementation of the present disclosure. Apparatus 500 may perform various functions to implement procedures, schemes, techniques, processes and methods described herein pertaining to emission and reception of patterned light waves for range sensing, including the various procedures, scenarios, schemes, solutions, concepts and techniques described above with respect to scenarios 100-400 described above as well as processes 600 and 700 described below.

Apparatus 500 may be a part of an electronic apparatus, a portable or mobile apparatus, a wearable apparatus, a wireless communication apparatus or a computing apparatus. For instance, apparatus 500 may be implemented in a smartphone, a smartwatch, a personal digital assistant, a digital camera, or a computing equipment such as a tablet computer, a laptop computer or a notebook computer. Moreover, apparatus 500 may also be a part of a machine type apparatus, which may be an Internet-of-Things (loT) or narrowband loT (NB-IoT) apparatus such as an immobile or a stationary apparatus, a home apparatus, a wire communication apparatus or a computing apparatus. For instance, apparatus 500 may be implemented in a smart thermostat, a smart fridge, a smart door lock, a wireless speaker or a home control center. Alternatively, apparatus 500 may be implemented in the form of one or more integrated-circuit (IC) chips such as, for example and without limitation, one or more single-core processors, one or more multi-core processors, one or more reduced-instruction-set-computing (RISC) processors or one or more complex-instruction-set-computing (CISC) processors.

Apparatus 500 may include at least some of those components shown in FIG. 5 such as a control circuit 505, an electromagnetic (EM) wave emitter or light emitter 510, and a first sensor 520 and. Optionally, apparatus 500 may also include a second sensor 530 and/or a display panel 550. Control circuit 505 may be coupled to, and in communication with, each of light emitter 510, first sensor 520, second sensor 530 and display panel 550 to control operations thereof. Light emitter 510 may be configured to emit a light (e.g., IR light and/or visible light) having a spatial pattern. Each of first sensor 520 and second sensor 530 may be configured to receive reflected waves of the light to generate sensor data, respectively. It is noteworthy that light emitter 510 may be positioned, located or otherwise arranged at any position on apparatus 500. It is also noteworthy that light emitter 510, first sensor 520 and second sensor 530 of apparatus 500 may be positioned, located or otherwise arranged on, in or under display panel 550.

Apparatus 500 may further include one or more other components not pertinent to the proposed scheme of the present disclosure (e.g., internal power supply, memory device and/or user interface device), and, thus, such component(s) of apparatus 500 are neither shown in FIG. 5 nor described below in the interest of simplicity and brevity.

In one aspect, control circuit 505 may be implemented in the form of an electronic circuit comprising various electronic components. Alternatively, control circuit 505 may be implemented as part of or in the form of one or more single-core processors, one or more multi-core processors, one or more RISC processors, or one or more CISC processors. That is, even though a singular term “a processor” is used herein to refer to control circuit 505, control circuit 505 may include multiple processors in some implementations and a single processor in other implementations in accordance with the present disclosure. In another aspect, apparatus 510 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, control circuit 505 is a special-purpose machine specifically designed, arranged and configured to perform specific tasks pertaining to emission and reception of patterned light waves for range sensing in accordance with various implementations of the present disclosure. In some implementations, control circuit 505 may include an electronic circuit with hardware components implementing one or more of the various proposed schemes in accordance with the present disclosure. Alternatively, other than hardware components, control circuit 505 may also utilize software codes and/or instructions in addition to hardware components to implement emission and reception of patterned light waves for range sensing in accordance with various implementations of the present disclosure.

Under various proposed schemes in accordance with the present disclosure, during operation, control circuit 505 may control light emitter 510 to emit a light having a spatial pattern toward a scene. Additionally, control circuit 505 may receive sensor data of the scene from one or more sensors (e.g., from first sensor 520 or both first sensor 520 and second sensor 530, depending on whether apparatus 500 is equipped with just first sensor 520 or with both first sensor 520 and second sensor 530). Moreover, control circuit 505 may perform range sensing of the scene using a plurality of techniques based on the sensor data.

In some implementations, in controlling light emitter 510 to emit the light, control circuit 505 may control light emitter 510 to emit the light in an IR spectrum or a visible spectrum.

In some implementations, in controlling light emitter 510 to emit the light, control circuit 505 may control light emitter 510 to emit continuous waves with the spatial pattern. Alternatively, or additionally, in controlling light emitter 510 to emit the light, control circuit 505 may control light emitter 510 to emit pulsed signals with the spatial pattern.

In some implementations, apparatus 500 may be equipped with just first sensor 520 but not second sensor 530. In such cases, in performing the range sensing of the scene using the plurality of techniques, control circuit 505 may perform certain operations. For instance, control circuit 505 may receive an image of the scene from first sensor 520. Moreover, control circuit 505 may perform the range sensing of the scene using structured light and TOF.

In some implementations, apparatus 500 may be equipped with both first sensor 520 and second sensor 530. In such cases, in performing the range sensing of the scene using the plurality of techniques, control circuit 505 may perform certain operations. For instance, control circuit 505 may receive a first image of the scene from first sensor 520 and a second image of the scene from second sensor 530. Moreover, control circuit 505 may perform the range sensing of the scene using active stereo and TOF.

In some implementations, control circuit 505 may be configured to control display panel 550 to adjust a transparency of display panel 550. For instance, in case that any of light emitter 510, first sensor 520 and second sensor 530 is disposed under display panel 550, control circuit 505 may control display panel 550 to increase its transparency to allow light emitted by light emitter 510 and waves of reflected light to traverse through the display panel 550.

### Illustrative Processes

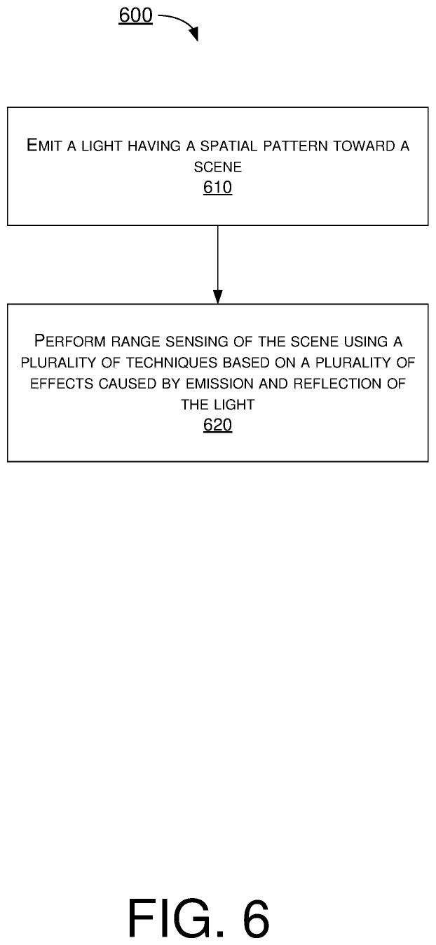

FIG. 6 illustrates an example process 600 in accordance with an implementation of the present disclosure. Process 600 may be an example implementation of the various procedures, scenarios, schemes, solutions, concepts and techniques, or a combination thereof, whether partially or completely, with respect to emission and reception of patterned light waves for range sensing in accordance with the present disclosure. Process 600 may represent an aspect of implementation of features of apparatus 500. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Furthermore, one or more of the blocks of process 600 may be repeated one or more times. Process 600 may be implemented by apparatus 500 or any variation thereof. Solely for illustrative purposes and without limitation, process 600 is described below in the context of apparatus 500. Process 600 may begin at block 610.

At 610, process 600 may involve light emitter 510 of apparatus 500 emitting a light having a spatial pattern toward a scene. Process 600 may proceed from 610 to 620.

At 620, process 600 may involve control circuit 505 of apparatus 500 performing range sensing of the scene using a plurality of techniques based on a plurality of effects caused by emission and reflection of the light.

In some implementations, in emitting the light, process 600 may involve light emitter 510 emitting the light in an IR spectrum or a visible spectrum.

In some implementations, in emitting the light, process 600 may involve light emitter 510 emitting continuous waves with the spatial pattern and/or pulsed signals with the spatial pattern.

In some implementations, the plurality of effects caused by the emission and reflection of the light may include a phase shift in reflected waves of the light, a time delay in reflected waves of the light, and a change in distance between features in the spatial pattern.

In some implementations, in performing the range sensing of the scene using the plurality of techniques, process 600 may involve control circuit 505 performing the range sensing of the scene using two or more of a plurality of active depth sensing techniques. In such cases, the plurality of active depth sensing techniques may include TOF, structured light, and active stereo.

In some implementations, in performing the range sensing of the scene using the plurality of techniques, process 600 may involve control circuit 505 performing the range sensing of the scene using a passive depth sensing technique and at least one of a plurality of active depth sensing techniques. In such cases, the passive depth sensing technique may include passive stereo, and the plurality of active depth sensing techniques may include TOF, structured light, and active stereo.

In some implementations, in emitting the light, process 600 may involve control circuit 505 controlling light emitter 510 to emit the light. In an event that apparatus 500 includes both first sensor 520 and second sensor 530, in performing the range sensing, process 600 may involve control circuit 505 performing certain operations. For instance, process 600 may involve control circuit 505 receiving a first image of the scene from first sensor 520 and a second image of the scene from second sensor 530. Moreover, process 600 may involve control circuit 505 performing the range sensing of the scene using active stereo and TOF.

In some implementations, in emitting the light, process 600 may involve control circuit 505 controlling light emitter 510 to emit the light. In an event that apparatus 500 includes first sensor 520 but not second sensor 530, in performing the range sensing, process 600 may involve control circuit 505 performing certain operations. For instance, process 600 may involve control circuit 505 receiving an image of the scene from first sensor 520. Moreover, process 600 may involve control circuit 505 performing the range sensing of the scene using structured light and TOF.

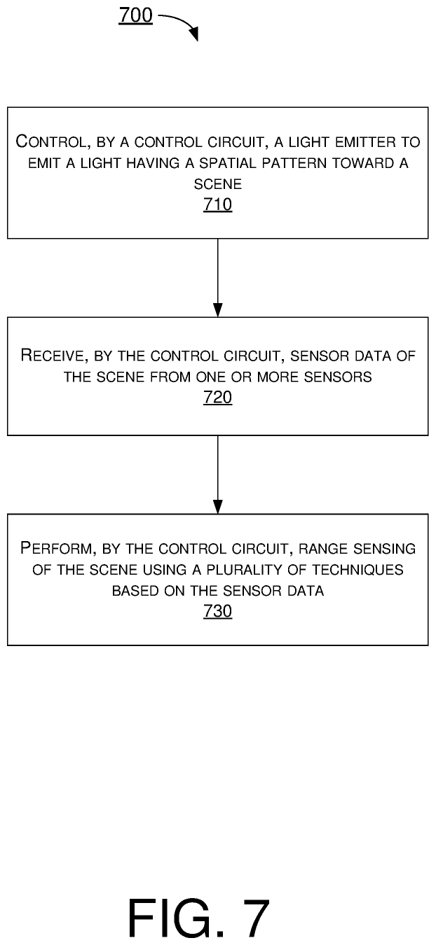

FIG. 7 illustrates an example process 700 in accordance with an implementation of the present disclosure. Process 700 may be an example implementation of the various procedures, scenarios, schemes, solutions, concepts and techniques, or a combination thereof, whether partially or completely, with respect to emission and reception of patterned light waves for range sensing in accordance with the present disclosure. Process 700 may represent an aspect of implementation of features of apparatus 500. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Furthermore, one or more of the blocks of process 700 may be repeated one or more times. Process 700 may be implemented by apparatus 500 or any variation thereof. Solely for illustrative purposes and without limitation, process 700 is described below in the context of apparatus 500. Process 700 may begin at block 710.

At 710, process 700 may involve control circuit 505 controlling light emitter 510 to emit a light having a spatial pattern toward a scene. Process 700 may proceed from 710 to 720.

At 720, process 700 may involve control circuit 505 receiving sensor data of the scene from one or more sensors (e.g., from first sensor 520 or both first sensor 520 and second sensor 530). Process 700 may proceed from 720 to 730.

At 720, process 700 may involve control circuit 505 performing range sensing of the scene using a plurality of techniques based on the sensor data.

In some implementations, in controlling light emitter 510 to emit the light, process 700 may involve control circuit 505 controlling light emitter 510 to emit the light in an IR spectrum or a visible spectrum.

In some implementations, in controlling light emitter 510 to emit the light, process 700 may involve control circuit 505 controlling light emitter 510 to emit continuous waves with the spatial pattern. Alternatively, or additionally, in controlling light emitter 510 to emit the light, process 700 may involve control circuit 505 controlling light emitter 510 to emit pulsed signals with the spatial pattern.

In some implementations, the one or more sensors may include a first sensor (e.g., sensor 520) and a second sensor (e.g., sensor 530). In such cases, in performing the range sensing of the scene using the plurality of techniques, process 700 may involve control circuit 505 performing certain operations. For instance, process 700 may involve control circuit 505 receiving a first image of the scene from the first sensor and a second image of the scene from the second sensor. Moreover, process 700 may involve control circuit 505 performing the range sensing of the scene using active stereo and TOF.

In some implementations, the one or more sensors may include a single sensor (e.g., sensor 520). In such cases, in performing the range sensing of the scene using the plurality of techniques, process 700 may involve control circuit 505 performing certain operations. For instance, process 700 may involve control circuit 505 receiving a first image of the scene from the first sensor and a second image of the scene from the second sensor. Moreover, process 700 may involve control circuit 505 performing the range sensing of the scene using structured light and TOF.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
emitting a light having a spatial pattern toward a scene; and
performing range sensing of the scene using a plurality of techniques based on a plurality of effects caused by emission and reflection of the light.

2. The method of claim 1, wherein the emitting of the light comprises emitting the light in an infrared (IR) spectrum or a visible spectrum.

3. The method of claim 1, wherein the emitting of the light comprises emitting continuous waves with the spatial pattern or pulsed signals with the spatial pattern.

4. The method of claim 1, wherein the plurality of effects caused by the emission and reflection of the light comprise a phase shift in reflected waves of the light, a time delay in reflected waves of the light, and a change in distance between features in the spatial pattern.

5. The method of claim 1, wherein the performing of the range sensing of the scene using the plurality of techniques comprises performing the range sensing of the scene using two or more of a plurality of active depth sensing techniques, and wherein the plurality of active depth sensing techniques comprise time-of-flight (TOF), structured light, and active stereo.

6. The method of claim 1, wherein the performing of the range sensing of the scene using the plurality of techniques comprises performing the range sensing of the scene using a passive depth sensing technique and at least one of a plurality of active depth sensing techniques, wherein the passive depth sensing technique comprises passive stereo, and wherein the plurality of active depth sensing techniques comprise time-of-flight (TOF), structured light, and active stereo.

7. The method of claim 1, wherein the emitting of the light comprises controlling a light emitter to emit the light, and wherein the performing of the range sensing comprises:
receiving a first image of the scene from a first sensor and a second image of the scene from a second sensor; and
performing the range sensing of the scene using active stereo and time-of-flight (TOF).

8. The method of claim 1, wherein the emitting of the light comprises controlling a light emitter to emit the light, and wherein the performing of the range sensing comprises:
receiving an image of the scene from a single sensor; and
performing the range sensing of the scene using structured light and time-of-flight (TOF).

9. A method, comprising:
controlling, by a control circuit, a light emitter to emit a light having a spatial pattern toward a scene;
receiving, by the control circuit, sensor data of the scene from one or more sensors; and
performing, by the control circuit, range sensing of the scene using a plurality of techniques based on the sensor data.

10. The method of claim 9, wherein the controlling of the light emitter to emit the light comprises controlling the light emitter to emit the light in an infrared (IR) spectrum or a visible spectrum.

11. The method of claim 9, wherein the controlling of the light emitter to emit the light comprises controlling the light emitter to emit continuous waves with the spatial pattern.

12. The method of claim 9, wherein the controlling of the light emitter to emit the light comprises controlling the light emitter to emit pulsed signals with the spatial pattern.

13. The method of claim 9, wherein the one or more sensors comprise a first sensor and a second sensor, wherein the receiving of the sensor data of the scene from the one or more sensors comprises receiving a first image of the scene from the first sensor and a second image of the scene from the second sensor, and wherein the performing of the range sensing of the scene using the plurality of techniques comprises performing the range sensing of the scene using active stereo and time-of-flight (TOF).

14. The method of claim 9, wherein the one or more sensors comprise a single sensor, wherein the receiving of the sensor data of the scene from the one or more sensors comprises receiving an image of the scene from the single sensor, and wherein the performing of the range sensing of the scene using the plurality of techniques comprises performing the range sensing of the scene using structured light and time-of-flight (TOF).

15. An apparatus, comprising:
a light emitter configured to emit a light having a spatial pattern;
one or more sensors configured to receive reflected waves of the light to generate sensor data; and
a control circuit coupled to the light emitter and the one or more sensors, the control circuit configured to perform operations comprising:
controlling the light emitter to emit the light having toward a scene;
receiving the sensor data of the scene from one or more sensors; and
performing range sensing of the scene using a plurality of techniques based on the sensor data.

16. The apparatus of claim 15, wherein, in controlling the light emitter to emit the light, the control circuit controls the light emitter to emit the light in an infrared (IR) spectrum or a visible spectrum.

17. The apparatus of claim 15, wherein, in controlling the light emitter to emit the light, the control circuit controls the light emitter to emit continuous waves with the spatial pattern.

18. The apparatus of claim 15, wherein, in controlling the light emitter to emit the light, the control circuit controls the light emitter to emit pulsed signals with the spatial pattern.

19. The apparatus of claim 15, wherein the one or more sensors comprise a first sensor and a second sensor, wherein, in receiving the sensor data of the scene from the one or more sensors, the control circuit receives a first image of the scene from the first sensor and a second image of the scene from the second sensor, and wherein, in performing the range sensing of the scene using the plurality of techniques, the control circuit performs the range sensing of the scene using active stereo and time-of-flight (TOF).

20. The apparatus of claim 15, wherein the one or more sensors comprise a single sensor, wherein, in receiving the sensor data of the scene from the one or more sensors, the control circuit receives an image of the scene from the single sensor, and wherein, in performing the range sensing of the scene using the plurality of techniques, the control circuit performs the range sensing of the scene using structured light and time-of-flight (TOF).
